(19) United States
(12) Patent Application Publication
(10) Pub. No.: US 2003/0001021 A1
(43) Pub. Date: Jan. 2, 2003

(54) Methods and control unit for temperature controlled devices

(76) Inventor: George Mazereeuw, Freckleton (GB)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,929

(22) Filed: Jun. 27, 2001

(51) Int. Cl. G05D 23/00

(52) U.S. Cl. 236/47; 236/51

(57) ABSTRACT

A method for operating a temperature controlled device includes detecting a human presence status and controlling a temperature of the temperature controlled device based upon the detected status.

### BACKGROUND OF INVENTION

This invention relates generally to temperature controlled devices and, more particularly, to controlling a temperature of a temperature controlled device.

At least some temperature controlled devices are refrigerant type cooling devices that include a compressor to compress a refrigerant and an evaporator that evaporates the refrigerant. During an evaporation process, the refrigerant expands and a temperature of the refrigerant lowers such that heat is absorbed providing a cooling of a main compartment of the cooling device. The evaporated refrigerant is then compressed by the compressor and then condensed into a liquid state by a condenser. The liquid refrigerant is then supplied to the evaporator completing the cycle.

Cooling devices require energy for operation. To conserve energy, cooling devices are often maintained at one temperature during business hours and maintained at a second temperature higher than the first temperature during non-business hours to conserve energy. For example, a cooling device may be set to operate at 3° Celsius (C.) during business hours and set to operate at 10° C. during non-business hours. Accordingly, less energy is utilized to maintain the cooling device at 10C.° than when the cooling device is set at 3° C. One technique to vary the cooling device's temperature involves manually adjusting a thermostat during a business day. Manual adjustments relay on the performance of employees and as such may be unreliable.

### SUMMARY OF INVENTION

In one aspect, a method for operating a temperature controlled device is provided. The method includes detecting a human presence status and controlling a temperature of the temperature controlled device based upon the detected status.

In another aspect, a method for fabricating a temperature controlled device includes providing a human presence detector and coupling the human presence detector to the temperature controlled device.

In a further aspect, a method for fabricating a control unit for a temperature controlled device includes providing a control unit and coupling a human detector to the control unit such that the control unit controls the temperature controlled device based on a human presence status.

In another aspect, a control unit for control of a temperature controlled device includes a human detector.

### BRIEF DESCRIPTION OF DRAWINGS

FIG. 1 is a perspective view of an exemplary embodiment of a cooling device.

FIG. 2 is a front view of a control unit according to one embodiment of the invention.

FIG. 3 is a side view of the cooling device shown in FIG. 1.

FIG. 4 is an alternative embodiment of a control system.

### DETAILED DESCRIPTION

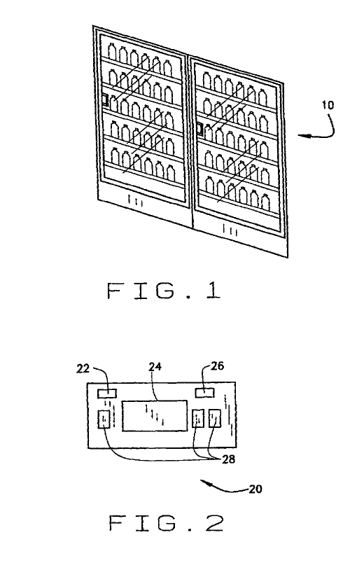

FIG. 1 is a perspective view of an exemplary embodiment of a cooling device 10 including a control unit (not shown in FIG. 1). In one embodiment, cooling device 10 is a commercial refrigerator such as a Gamko model number GR 038600RS420 commercially available from Gamko Holding, AL Etten Leur, Holland. In another embodiment, cooling device is a stand alone cooling cabinet such as a GR-05013XSS420 stand alone cooling cabinet commercially available from Gamko Holding, AL Etten Leur, Holland. In another embodiment, cooling device 10 is a commercial bottle cooling cabinet such as Gamko Maxiglass cabinet model numbers MXB-20/150 and 20/250 commercially available from Gamko Holding, AL Etten-Leur, Holland. In a further embodiment, cooling device 10 is a commercial freezer such as Gamko model numbers GF-100600RS420 and GF-12513XSS420 also commercially available from Gamko Holding, AL Etten-Leur, Holland. Alternatively, cooling device 10 is a residential refrigerator or refrigerator/freezer unit such as a GE Profile Arctic Top Freezer/Refrigerator model number PTS22LBMWW commercially available from General Electric Company, General Electric Appliances, Louisville, Ky. In an exemplary embodiment, cooling device 10 includes a known compressor (not shown), a known condenser (not shown), and a known evaporator (not shown). Cooling device 10 utilizes a refrigerant (not shown) to cool a main storage compartment 12 wherein cooled or frozen products are stored. In one embodiment, the refrigerant is either Ammonia or Freon. In another embodiment, the refrigerant is neither Ammonia nor Freon. Cooling devices 10 include, but are not limited to refrigerators, freezers, refrigerator/freezers, chillers, ice builders or ice makers, refrigerated cabinets, cold storage cells, walk in coolers and freezers, and other refrigerant type cooling units including units utilizing all refrigerants. Therefore, as used herein, “cooling device” refers to refrigerant type cooling units which have a compartment for storing cooled or frozen products. It is contemplated that the benefits of the invention accrue to heating devices such as commercial cooking appliances including commercial ovens, heating bins, and deep fat fryers, and domestic appliances such as residential ovens and cooktops. As used herein, “heating devices” refers to thermostatically controlled heating apparatuses other than furnaces. Additionally, it is contemplated that the benefits of the invention accrue to all temperature controlled devices and, accordingly, as used herein “temperature controlled devices” refers to all cooling devices and all heating devices.

FIG. 2 is a front view of an exemplary embodiment of a control unit 20. Control unit 20 includes a human detector 22. In one embodiment, control unit 20 includes human detector 22 coupled to a known control device such as a model TC-110 control unit commercially available from Elstat Electronics LTD, Lancashire, England. Control unit 20 also includes a temperature indication lens 24, a mode indicator 26, and a plurality of function buttons 28. In one embodiment, detector 22 is a motion detector. In another embodiment, detector 22 is an infrared detector. In a further embodiment detector 22 is a vibration detector. Control unit 20 is coupled to cooling device 10 and controls a temperature within compartment 12. Control unit 20 is programmable to set a temperature of compartment 12 using signals from detector 22 which indicate a human presence status. When detector 22 detects a presence of a human then the status is “human present” and cooling device 10 is controlled at a first temperature. When detector 22 does not detect the presence of a human, then the status is “human absent” which is transmitted to control device 20 and cooling device 10 is controlled at a second temperature.

During operation, a retailer uses at least one cooling device 10 to offer cooled products for sale. To lower or avoid energy consumption, control unit 20 is programmed to operate at a first temperature that is colder than a second temperature. For example, control unit is programmed to operate at a first temperature of approximately 3° C. (Celsius) and a second temperature of approximately 10° C. During business hours, detector 22 detects customers and/or employees passing by detector 22, and because a “human present” signal is provided to control unit 20, the cooled product is maintained at approximately the first temperature. During non-business hours, employees and/or customers are no longer present, and because a “human absent” signal is provided to control unit 20, the cooled product is maintained approximately at the second temperature. Because it is typically less costly to maintain a higher temperature than a lower temperature within cooling device 10, lower energy costs are associated using control unit 20 than without using control unit 20. Since the temperature is automatically adjusted based upon a human presence, and not in reliance on an employee making manual adjustments to the temperature, inherent risks of human error and forgetfulness are reduced. In one embodiment, detector 22 is integral with control unit 20. In another embodiment, detector is not integral with control unit 20.

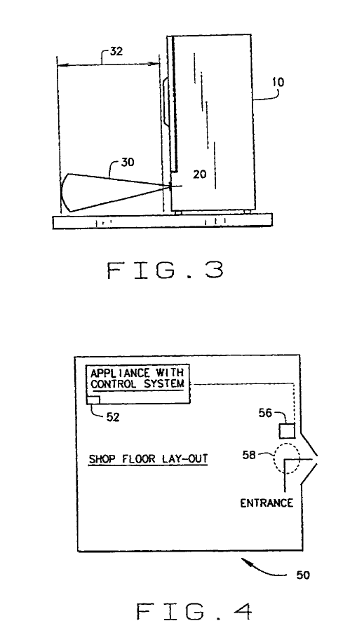

FIG. 3 is a side view of cooling device 10 (shown in FIG. 1) including control unit 20 (shown in FIG. 2), and illustrating a detection area 30 that is proximate cooling device 10. When a human is present within detection area 30, cooling device 10 is controlled at the first temperature as described above. Detection area 30 includes a length 32. In one embodiment, length 32 is adjustable by a retailer. In an exemplary embodiment, a time delay is programmed into control unit 20, such that cooling device 10 is controlled at the first temperature for a specified period of time regardless of a human absent status. The delay is programmed based upon the retailer's traffic patterns. If a retailer is typically very busy during business hours, then a relatively short time delay of 10 minutes is programmed. If a retailer typically has extended non-busy periods during business hours, then a relatively long time delay of one hour is programmed. The time delay programmed reduces a number of on/off cycles for a cooling system (not shown) of cooling device 10. In some cooling applications, the retailer or other owner of cooling device 10 does not desire any cooling during non business hours, and, during a status of “human absent”, a second temperature is not specified, and rather, the cooling system or cooling device 10 is shut off when a “human absent” status is detected by detector 22. A time delay is also utilized to reduce cycling and the time delay is adjustable by the owner of cooling device to suit the owner's particular traffic patterns.

FIG. 4 is an alternative embodiment of a control system 50 including a control unit 52 that is operationally coupled to a cooling device 54. A remote human detector 56 is operationally coupled to control unit 52. In one embodiment, remote detector 56 is electronically coupled to control unit 52. In another embodiment, remote detector 56 is in wireless communication with control unit 52. Remote detector 52 detects a presence of humans in a detection area 58 that is distant from cooling device 54.

Control unit 52 is programmed to set a temperature within a compartment (not shown) based upon signals from remote detector 56 representing a human presence status in detection area 58. When remote detector 56 detects a human, the status is “human present” and cooling device 54 is controlled at a first temperature. When remote detector 56 does not detect the presence of a human in detection area 58 then the status is “human absent” and cooling device 54 is controlled at a second temperature.

During operation, at least one cooling device 54 contains cooled products. Control unit 52 is programmed such that a first temperature is colder than a second temperature. For example, the first temperature is approximately 3° C. and the second temperature is approximately 10° C. During business hours, remote detector 56 detects customers and/or employees in detection area 58, and because a “human presence” signal is provided to control unit 52, the cooled product is maintained at approximately the first temperature. During non-business hours, remote detector 56 detects an absence of customers and/or employees, and because a “human absent” signal is provided to control unit 52, the cooled product is maintained at the second temperature. Because it is typically less costly to maintain a higher temperature than a lower temperature in cooling device 54, lower energy costs are associated using control unit 52 and remote detector 56 than without using control unit 52 and remote detector 56. Since the temperature is automatically adjusted based upon a human presence in detection area 58 and not on an employee making manual adjustments to the temperature, inherent risks of human error and forgetfulness are reduced.

When a human is present in detection area 58, cooling device 54 is controlled at the first temperature as explained above. In an exemplary embodiment, a delay time is programmed into at least one of control unit 52 and remote detector 56 such that cooling device 54 is controlled at the first temperature for a specified period of time regardless of a human absent status. The delay time is programmed based upon a retailer's traffic patterns. If a retailer is typically very busy during business hours, then a relatively short time delay of ten minutes is programmed. If a retailer typically has extended non-busy periods during business hours then a relatively long time delay of one hour is programmed. The programmed time delay reduces the number of on/off cycles for a cooling system (not shown) of cooling device 54. In some cooling applications, the retailer or other owner of cooling device 54 does not desire any cooling during non business hours, and, during a status of human absent, a second temperature is not specified, and rather, the cooling system or cooling device 54 is shut off when a “human absent” status is detected by remote detector 58. A time delay is also utilized to reduce cycling and the time delay is programmed according to the owners particular traffic patterns.

While the invention has been described in terms of a controlling the temperature of a cooling device in a retail environment, it is contemplated that the benefits of the invention accrue to cooling devices not in a retail environment and to heating devices. For example, restaurant heating devices such as a grill and a deep fat fryer are typically operated at a first temperature during business hours and a second temperature during non-business hours. More specifically, a deep fat fryer is typically operated at a particular temperature during business hours and turned off during non-business hours. The fryer is typically turned on and off manually by an employee of the restaurant. However, if the employee forgets to turn off the fryer during non-business hours then the fryer consumes more energy than if the fryer was turned off. Additionally, a heating device inadvertently left on may pose a fire hazard. Accordingly, utilizing a human detector such as human detectors 22 and 56 to control the temperature of a heating device lowers energy consumption and facilitates a reduction in fires.

While the invention has been described in terms of various specific embodiments, those skilled in the art will recognize that the invention can be practiced with modification within the spirit and scope of the claims.

1. A method for operating a temperature controlled device, said method comprising the steps of:
detecting a human presence status; and
controlling a temperature of the temperature controlled device based upon the detected status.

2. A method according to claim 1 wherein said step of detecting a human presence status comprises the step of detecting a human presence status utilizing at least one of a motion detector, an infrared sensor, and a vibration sensor.

3. A method according to claim 1 wherein said step of detecting a human presence status comprises the step of detecting a human presence utilizing a motion detector.

4. A method according to claim 1 wherein said step of detecting a human presence status comprises the step of detecting a human presence status in an area proximate to the temperature controlled device.

5. A method according to claim 1 wherein said step of detecting a human presence comprises the step of detecting a human presence in an area distant to the temperature controlled device.

6. A method according to claim 1 wherein said step of controlling a temperature comprises the steps of:
specifying a first temperature of the temperature controlled device comprising a cooling device when the detected status is human present; and
specifying a second temperature of the temperature controlled device when the detected status is human absent, the second temperature higher than the first temperature.

7. A method according to claim 1 wherein said step of controlling a temperature comprises the steps of:
specifying a first temperature of the temperature controlled device comprising a cooling device when the detected status is human present; and
specifying a second temperature of the temperature controlled device after detecting a human absent status for a predetermined period of time, the second temperature higher than the first temperature.

8. A method according to claim 1 wherein said step of controlling a temperature comprises the step of turning off the temperature controlled device when the detected status is human absent.

9. A method according to claim 1 wherein said step of controlling a temperature comprises the step of turning off the temperature controlled device after detecting a human absent status for a predetermined period of time.

10. A method according to claim 1 wherein said step of controlling a temperature comprises the steps of:
specifying a temperature of the temperature controlled device when the detected status is human present; and
turning off the temperature controlled device when the detected status is human absent.

11. A method according to claim 1 wherein said step of controlling a temperature comprises the steps of:
specifying a temperature of the temperature controlled device when the detected status is human present; and
turning off the temperature controlled device after detecting a human absent status for a predetermined period of time.

12. A method according to claim 1 wherein said step of controlling a temperature comprises the steps of:
specifying a first temperature of the temperature controlled device comprising a heating device when the detected status is human present; and
specifying a second temperature of the temperature controlled device when the detected status is human absent, the second temperature lower than the first temperature.

13. A method according to claim 1 wherein said step of controlling a temperature comprises the steps of:
specifying a first temperature of the temperature controlled device comprising a heating device when the detected status is human present; and
turning off the temperature controlled device after detecting a human absent status for a predetermined period of time.

14. A method for fabricating a temperature controlled device, said method comprising:
providing a human presence detector; and
coupling the human presence detector to the temperature controlled device such that the temperature controlled device is controlled based on a human presence status.

15. A method according to claim 14 wherein said step of providing a human presence detector comprises the step of providing at least one of a motion detector, an infrared sensor, and a vibration sensor.

16. A method according to claim 14 wherein said step of coupling the human presence detector comprises coupling the human presence detector to the temperature controlled device comprising a cooling device.

17. A method according to claim 14 wherein said step of coupling the human presence detector comprises coupling the human presence detector to the temperature controlled device comprising a heating device.

18. A method for fabricating a control unit for a temperature controlled device, said method comprising the steps of:
providing a control unit; and
coupling a human detector to the control unit such that the control unit controls the temperature controlled device based on a human presence status.

19. A control unit for control of a temperature controlled device, said control unit comprising a human detector.

20. A control unit according to claim 19 wherein said human detector comprises at least one of a motion detector, an infrared sensor, and a vibration sensor.

21. A control unit according to claim 19 wherein said control unit configured to control the temperature controlled device based on a human presence status.

22. A control unit according to claim 21 wherein said control unit further configured to:
control the temperature controlled device at a first temperature when said human detector detects a human present status; and
control the temperature controlled device at a second temperature when said human detector detects a human absent status.

23. A control unit according to claim 22 wherein said second temperature higher than said first temperature.

24. A control unit according to claim 22 wherein said second temperature lower than said first temperature.

25. A control unit according to claim 19 wherein said detector configured to detect a human presence status in an area proximate said control unit.

26. A control unit according to claim 19 wherein said detector configured to detect a human presence status in an area distant said control unit.

27. A control unit according to claim 21 wherein said control unit further configured to:
control the temperature controlled device at a first temperature when said human detector detects a human present status; and
control the temperature controlled device at a second temperature after said human detector detects a human absent status for a predetermined period of time.

28. A control unit according to claim 21 wherein said control unit further configured to:
control the temperature controlled device at a first temperature when said human detector detects a human present status; and
turn off the temperature controlled device when said human detector detects a human absent status.

29. A control unit according to claim 21 wherein said control unit further configured to:
control the temperature controlled device at a first temperature when said human detector detects a human present status; and
turn off the temperature controlled device after said human detector detects a human absent status for a predetermined period of time.
